(19) United States
(12) Patent Application Publication
(10) Pub. No.: US 2005/0121392 A1
(43) Pub. Date: Jun. 9, 2005

(54) Chromatographic system with mobile phase recycling ability

(76) Inventor: Bernd Hoffman, Karlsruhe (DE)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 11/006,812

(22) Filed: Dec. 8, 2004

(30) Foreign Application Priority Data
Dec. 9, 2003 (EP) 03028082.0

(51) Int. Cl. B01D 15/08

(52) U.S. Cl. 210/656; 210/198.2; 436/161; 422/170; 210/143

(57) ABSTRACT

A chromatographic system includes a stationary phase, a mobile phase flow line, a detector, a mobile phase supply system, an injection device and a mobile phase switch. A controlling system in data communication with the detector and the mobile phase supply system automatically directs the flow of the mobile phase via the mobile phase switch to different containers depending on the data received by the detector and the mobile phase supply system.

The present invention relates to chromatographic systems.

### BACKGROUND OF THE INVENTION

Liquid chromatography, for example high performance liquid chromatography (HPLC) is a widespread separation technique, wherein a mixture of different components to be analyzed is dissolved in a liquid mobile phase. The mobile phase is applied to a stationary phase, normally a column, where the different components can interact in a different way with the stationary phase so the components elute from the column at different times, (when a solvent is used). Often a gradient elution, including a mobile phase gradient wherein the composition of the mobile phase is changed overtime, has to be run in order to elute the different components from the column. The separated components of interest, often called analytes, leaving the stationary phase are normally detected using a suitable detector, for example a UV or mass spectrometer (MS) detector. The representation of the detector signal as a function of time is called chromatogram. The chromatogram shows so-called (signal) peaks, which represent different components.

In preparative HPLC the operation of a chromatographic system normally requires a considerable amount of user input. This especially accounts for the direction of flow of the mobile phase after the mobile phase has passed the column. A mobile phase containing components of interest (analytes) typically is directed into a fraction collector for further analysis. Mobile phases containing constituents of no further interest are frequently drained into waste, whereas mobile phases with exactly the same composition as the phase at the beginning are often directed back into their original container for recycling purposes. A mobile phase switch, for example a valve, normally directs the flow of the mobile phase. The position of this valve is changed depending on the composition of the mobile phase in order to direct the flow of the mobile phase into the different containers mentioned above.

The Japanese patent application publication JP 10197506 A discloses a chromatographic system with solvent recycling abilities. A solvent recycling system including a microcomputer with a level setting section is part of the detector. In response to the signal of the detector exceeding a certain threshold level, i.e. a (signal) peak is detected, the valve is changed so that the mobile phase is directed into a specified collection vessel or into waste. In response to the signal not exceeding the threshold level, the solvent is considered to have the original composition of the solvent applied to the stationary phase and is redirected into the original reservoir of the original phase for recycling purposes.

### SUMMARY OF THE INVENTION

It is an object of the present invention to provide a new and improved chromatographic system.

In order to operate the chromatographic system according to embodiments of the invention, a stationary phase is loaded into a container; alternatively, an already pre-packed stationary phase in an HPLC column might be provided and connected to the other components of the system via the mobile phase flow line. Furthermore a mobile phase, immiscible with the stationary phase, for performing a distribution equilibrium of analytes of interest between the mobile and stationary phases is provided.

In the chromatographic system according to certain aspects of the invention, a controlling system receives data from a detector (e.g. information about composition changes of the mobile phase and the presence of components eluted from the stationary phase e.g. analytes of interest or impurities) and data from the mobile phase supply system (e.g. information about the mobile phase flow rate and the composition of the mobile phase applied to the stationary phase). After processing these data, the controlling system directs the flow of the mobile phase passed through the stationary phase into different locations depending on the data. Since the controlling system is adapted to control the mobile phase switch, it automatically directs the flow of the mobile phase into different locations, depending on the composition of the mobile phase and the presence of components eluted from the stationary phase. Therefore, minimal user input is required for the chromatographic system of the invention.

Advantageously the mobile phase supply system includes a pump that is controlled by the controlling system.

In another embodiment of the chromatographic system of the invention, the mobile phase switch comprises a valve. Depending on the number of desired flow directions, the valve includes a plurality of ports with openings in the valve for different flow paths. Therefore, such a valve includes plural openings, i.e., ports, for directing the flow to different locations. Typical valves include six ports or even ten-ports.

In a further embodiment of the chromatographic system, the valve includes flow passages and port openings that might differ in their geometrical dimensions to address specific physical demands of the flow system.

Advantageously the detector and the mobile phase supply system include microprocessors for communication with the controlling system. The microprocessors process data recorded at the mobile phase system or the detector in order to ease the processing of these data within the controlling system.

Preferably the mobile phase flow line comprises at least one of the following components: tubes, capillaries and sample injector. Tubes and capillaries for high performance liquid chromatographic systems (HPLC systems) are especially designed and manufactured to fulfill their different individual chromatographic needs. The tubes and capillaries can be identical or different in length and inner diameter.

In preferred embodiments, a diode array based UV detector (DAD) measures the total spectrum of the mobile phase composition passed through a stationary phase and the spectrum of components eluted from the stationary phase at any time during a run, to monitor the mobile phase and any components in the mobile phase having a different origin from the mobile phase. For example the diode array based UV detector can simultaneously monitor the spectra of the components eluted at wavelengths of e.g. 254 nm, 210 nm and 260 nm/280 nm. These three different, individually defined wavelengths allow the simultaneous detection of aromatic compounds (254 nm), of peptides (210 nm), and other substances, e.g. nucleic acids (260 nm/280 nm). The composition of the mobile phase is typically monitored over the entire spectral range, starting from 190 nm or 200 nm, depending on the optical quality of the detector. Once the controlling system has determined that the composition of the mobile phase passing the stationary phase has exactly or nearly the same spectrum (e.g. UV spectrum) as the initial mobile phase composition that was applied to the stationary phase, this mobile phase is easily redirected back to the original storage container for recycling.

This is possible because a direct flow line connection between the mobile phase switch and the storage container is part of the system. In the case of components eluted from the stationary phase being monitored by the detector, the mobile phase containing such components is directed into (1) waste if the components are impurities or (2) a fraction collector for further analysis if the components are analytes of interest.

Advantageously the controlling system is adapted to combine (1) data of the composition of a mobile phase before the mobile phase enters the stationary phase and (2) those data that have been detected after the mobile phase composition has just passed the detector. Data (1) and (2) are preferably received from the mobile phase supply system and the detector, respectively.

The combination of data, the composition of the eluent flow with/without injected samples results in (1) and (2) and easy further processing of all the data from the detector and the mobile phase supply system within the controlling system.

Preferably the mobile phase supply system provides data about the mobile phase flow rate and composition per time unit and the detector provides at least one or a combination of the following data: change in refractive index, UV absorption, fluorescence intensity, m/z ratio in mass spectroscopy, light scattering intensity for determining the composition of the mobile phase and the presence of components eluted from the stationary phase at a specific time during a run.

In the case of analyte destroying detectors being used, e.g. mass spectrometers for determining the m/z ratio of analytes, a flow-splitter is advantageously provided. This flow-splitter divides the mobile phase flow line into first and second separate flow lines: the first flow line is for the majority of the mobile phase leading to the mobile phase switch and the second flow line is for a small fraction of the mobile phase flowing to the analyte destroying detector for analysis. The small fraction of the mobile phase in the second flow line is analyzed by the detector and the mobile phase switch connected to the first flow line is subsequently controlled according to the information received from the analysis and/or the mobile phase supply system.

The detector can also include different types of spectrometers, for example a UV spectrometer and a refractive index (RI) detector to provide an easier determination of the composition of the mobile phase by using and combining different detection methods.

Preferably the mobile phase flow rate generated by the mobile phase supply system is variably adjustable by the controlling system according to data received from the detector. Variable adjustment of the mobile phase flow rate, for example, allows an easy adaptation of the mobile phase flow rate and composition of the mobile phase, which passes through the stationary phase according to the composition of the mobile phase that is leaving the stationary phase and is monitored by the detector.

Therefore the chromatographic system can be adapted, for example, to enhance the flow rate and/or its mobile phase composition once a certain event has taken place (e.g. the substance of interest has been eluted from the stationary phase and has been detected in the detector).

Thus, an enhanced mobile phase flow rate accelerates the equilibration of the stationary phase with a new mobile phase composition for the following chromatographic run in order to reduce the overhead time necessary to bring the total system back to the starting conditions.

Advantageously, the controlling system comprises a computer system connected to the controlling system. The computer system processes and analyzes the data received from the detector and the mobile phase supply system. The computer system preferably is adapted to control the mobile phase switch, the valve, and the mobile phase supply system. The computer system can include a stationary system, e.g., a desktop computer or a handheld control system that monitors chromatographic run (see for example FIGS. 2 and 3) and has manual inputs responsive to a user.

Furthermore, the mobile phase switch can comprise a second detector for a test compound, wherein the mobile phase switch provides data about the test compound to the controlling system.

The second detector for the test compound can comprise a photo-diode for detection of a dye in the test compound. For example, a blue emitting dye can be detected by using a red laser photo-diode built into the mobile phase switch, e.g. the valve. The dye serves as a test compound, which enables the controlling system to determine the delay volume between the UV detector and the mobile phase switch.

In the case of a blue emitting dye in the test compound, the controlling system receives data from the detection system about the time the dye in the test compound is detected (1) by the detector and (2) at the mobile phase switch. This embodiment of the chromatographic system of the invention allows a very precise determination of the delay time and thus the delay volume between the detector and the mobile phase switch. A detection system for determining the delay time is also disclosed in the U.S. Pat. No. 6,106,710, which is hereby incorporated in its entirety.

In other cases, where an exact determination of the dead volume is not necessary, the controlling system simply determines the dead volume between the mobile phase supply system and the mobile phase switch by using data about the mobile phase flow rate and the volume available for the mobile phase between the mobile phase supply system and the mobile phase switch. A detection system for a test compound in the mobile phase switch is, for example, shown in FIG. 3.

In another advantageous embodiment of the chromatographic system of the invention, a mobile phase mixer is part of the system. The mobile phase mixer might generates a mobile phase gradient by actively bringing at least two different initial eluents together and mixing them, as for example shown in FIG. 3. In this case the controlling system controls the mobile phase mixer, thereby enabling the mixing of at least two different initial eluents resulting in a mobile phase to be applied onto the stationary phase.

In another embodiment of the chromatographic system of the invention, the mobile phase supply system combines two different initial eluents to a mobile phase. In this case the mobile phase mixer is part of the mobile phase supply system as shown in FIG. 1. The mobile phase mixer then actively mixes (e.g. by using a stirrer blade) or passively mixes (e.g. by using beads) the already combined initial eluents ensuring complete mixing.

Using the different mobile phase mixers and mobile phase supply systems, mobile phases of different composition are generated in order to run gradients with linear and/or non-linear mobile phase compositions. Typically two different eluents are mixed together to form the mobile phase of interest. Normally the two different eluents have different compositions, differing in at least one component of the eluent. The two different eluents are e.g. acetonitrile and water. The two different eluents might also comprise the same solvents, but differ in the concentration of a salt.

A gradient mixer, typically controlled by the mobile phase pump or the controlling system, allows more complex chromatographic procedures, for the separation of substances when using a mobile phase gradient.

In a chromatographic system of the invention, which is able to run a gradient elution, the controlling system is preferably adapted to direct various mobile phases of different compositions, passed through the stationary phase via the mobile phase switch into at least one container, and the controlling system is adapted to determine the composition of the new mobile phase in the at least one container by using data received from the mobile phase supply system and the detector. In this embodiment, the chromatographic system is adapted to determine the composition of the mobile phase passed through the stationary phase and direct mobile phases of different composition having no or only minor contaminations after passing the stationary phase into at least one container. For example, mobile phases without impurities varying from 70% acetonitrile: 30% water to 90% acetonitrile: 10% water are collected in a container, resulting in a new mobile phase with a different composition. Furthermore the controlling system is adapted to allow the calculation of the thus formed new composition of the new mobile phase. The controlling system receives data from the detector and the mobile phase supply system about the mobile phase flow rate, the composition of the mobile phase at the beginning of the gradient, the composition of the mobile phase at the end of the gradient, the purity of the mobile phase, the steepness(es) of the gradient(s) and its (their) duration and the occurrence time of the mobile phase at the detector. The controlling system can use all these data in order to determine the composition and the purity of the new mobile phase in the container. In the case, of two or even more gradients being run during one chromatographic procedure, the mobile phases of each gradient passed through the stationary phase can be collected in one container, the container being different each time, so that two or even more mobile phases with new compositions can be generated by the chromatographic system of the invention.

Preferably an electronic microprocessor for direct data communication between the mobile phase supply system and the detector is part of the system. The electronic microprocessor can be part of at least the mobile phase supply system or the detector or both. Such a microprocessor can enable a direct and easy communication between the mobile phase supply system and the detector as, for example, shown in FIG. 3. The communication between the mobile phase supply system and the detector via their microprocessors can also involve local area network systems, for example, a communication local area network (CAN).

The operating method according to embodiments of the present invention allows automatic direction of the mobile phase to different locations depending on the composition of the mobile phase and the presence or absence of analytes or impurities.

Preferably at least one of the following data the mobile phase that has passed the stationary phase (and, if present, compounds eluted from the stationary phase) is received from the detector: current refractive index, UV spectrum, florescence spectrum, TIC mass spectrum, or light scattering capability at a particular time when passing the detector.

A further aspect of the invention relates to a method of operating a chromatographic system, the system including a mobile phase supply system that delivers a mobile phase, a stationary phase, a sample injector, a detector and a mobile phase switch that directs the flow of a mobile phase to different locations, all being connected via a mobile phase flow line. The method comprises (A) applying an initial mobile phase to the stationary phase using the mobile phase supply system by mixing together at least two different eluents in a variable manner resulting in the initial mobile phase being applied to the stationary phase, while the stationary phase is running a gradient elution and/or a step gradient elution, (B) determining the composition and purity of the mobile phase after the mobile phase has passed the stationary phase; step (B) is performed by using data received from the detector band data and from the mobile phase supply system; (C) directing the mobile phase passed through the stationary phase into a container depending on the data received in step (B) by using the mobile phase switch whereby the mobile phases of different compositions are directed to at least one container resulting in a new mobile phase; and (D) determining the composition of the new mobile phase by using data received in step (B).

Furthermore in step (B) at least one of the following data is received from the mobile phase supply system: flow rate of the mobile phase applied to the stationary phase, composition of this mobile phase, duration of delivery of this mobile phase at a particular composition and thus the mobile phase gradient steepness.

Such data received from the detector and the mobile phase supply system enable a very simple automated determination of the composition of the mobile phase and its purity after the composition has passed the stationary phase.

Advantageously in step (A), at least two different initial eluents are mixed together in a timely variable manner resulting in a mobile phase for application to the stationary phase, running a linear gradient elution and/or a step gradient elution. In this embodiment, the composition of the mobile phase is determined in step (B) by using additional data received from the mobile phase supply system. Preferably at least one of the following additional data is received from the mobile phase supply system: composition of the mobile phase at the beginning of the gradient, composition of the mobile phase at the end of the gradient and duration of the gradient.

Such an embodiment of the method of the invention enables an automatic determination of the composition of the mobile phases passed through the stationary phase during gradient elution and/or step gradient elution procedures.

It is also possible to recycle a mobile phase having a constant composition during an isocratic chromatographic run.

Preferably in step (C) mobile phases of different composition are automatically directed to at least one container, resulting in a new mobile phase. In step (D) the composition of this new mobile phase is automatically determined using data received in step (B) from the mobile phase supply system and the detector.

This embodiment of the method of the invention allows the generation of freshly adjusted mobile phases by mixing mobile phases of different compositions passed through the stationary phase to a completely new composition and thus provides an enhanced and simplified mobile phase recycling. This embodiment enables recycling of mobile phases with defined lower contamination than is obtained by performing the gradient elution prior to use. A chromatographic system that is able to be operated using such a method is shown in FIG. 3. This operating method of the invention allows the recycling of used mobile phases with variant compositions in one container, so that a new mobile phase is generated with a new composition, which can automatically be determined by the system.

Preferably at least one container for storage of the mobile phase is used. In this case it is possible to automatically direct, in step (C), the mobile phase that is passed through the stationary phase with the same composition as the mobile phase that is applied to the stationary phase in the at least one container. This method of the invention allows direct recycling of mobile phases without major impurities back into the storage container, which is connected to the mobile phase switch via a mobile phase flow line (see e.g. FIG. 1). This method of the invention enables an immediate reuse of the recycled mobile phases because the container can also be connected to the mobile phase supply system.

In a further variant the delay time of the mobile phase between the mobile phase switch and either the mobile phase supply system (in the case of an isocratic run) or the mobile phase mixer (in the case of a gradient run) is automatically determined by using at least one of the following data: refractive index, UV spectrum, florescence spectrum, TIC mass spectrum, light scattering received from the detector for determination of the composition change of the mobile phase at a particular time of the mobile phase in the detector, information about the mobile phase flow rate received from the mobile phase supply system, and the physical volume of the mobile phase flow line connecting the detector and the mobile phase switch.

Such variants allow the determination of the delay volume and therefore the delay time of the mobile phase between the mobile phase supply system and the mobile phase switch. The delay time or delay volume between the mobile phase supply system and the mobile phase switch basically includes two different delay volumes. The first delay volume is the delay volume between the mobile phase supply system or the mixer and the detector and the second delay volume is the delay volume between the detector and the mobile phase switch (see for example FIG. 1). The delay volume between the mobile phase supply system and the detector can be determined by using data about the mobile phase flow rate and the composition of the mobile phase delivered from the mobile phase supply system and the data received from the detector indicating the composition of the mobile phase that passed the stationary phase and the time of occurrence of the mobile phase at the detector. The delay volume between the detector and the mobile phase switch is determined by using information about the physical volume of the mobile phase flow line connecting the detector and the mobile phase switch and information about the mobile phase flow rate.

Embodiments of the invention thus enable automatic running of the chromatographic system under chromatographic modes different from the isocratic mode. Furthermore any problems occurring during the chromatographic process can be indicated, such as wear of mechanically permanent moving parts. An automatic chromatographic procedure can be provided, wherein the mobile phase is automatically directed into waste, into the original container or into a fraction collector, depending on the mobile phase composition and the presence or absence of analytes in the mobile phase.

In the following the invention will be described in more detail by the figures and embodiments. All figures are just simplified schematic representations presented for illustrative purposes only.

### BRIEF DESCRIPTION OF THE DRAWINGS

FIG. 1 is a schematic diagram of one preferred embodiment of a chromatographic system including the controlling system of the invention.

FIG. 2 is a schematic diagram of another embodiment of the chromatographic system of the invention for isocratic chromatographic runs.

FIG. 3 is a schematic diagram of a chromatographic system of the invention able to run a gradient elution.

FIG. 4 is a chromatogram of the type produced by the detectror of FIG. 3.

### DETAILED DESCRIPTION OF OF THE DRAWING

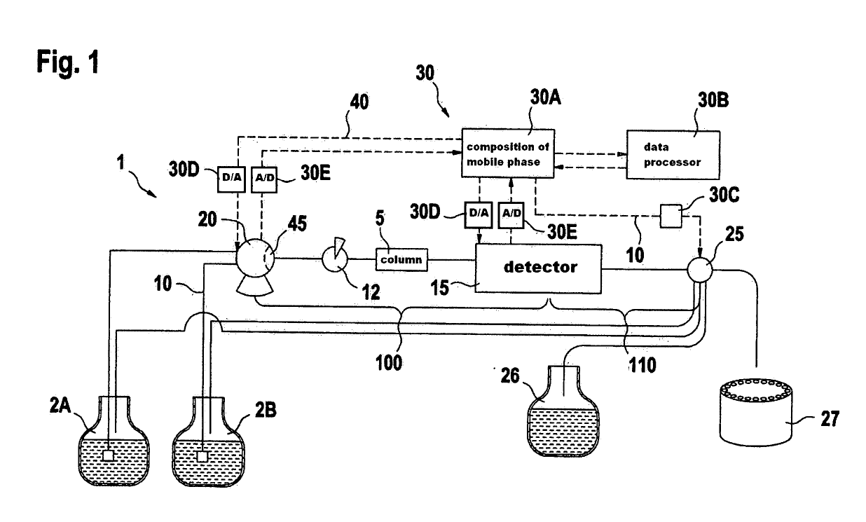

FIG. 1 is a schematic representation of a chromatographic system 1 able to run a gradient elution. Solid lines in FIG. 1 and all the other figures represent the mobile phase flow line 10, whereas dashed lines represent data communication lines 40. The chromatographic system comprises a mobile phase supply system 20, which in this case is a pump with a mobile phase mixer 45, a stationary phase 5, for example a column, a detector 15 and a mobile phase switch 25 which are all in flow communication through a flow line 10. The pump 20 is connected via the mobile phase flow line 10 to two containers 2A and 2B each container having a different eluent (e.g. water and acetonitrile). The pump 20 is adapted to deliver the mobile phase via the mobile phase flow line 10 to the stationary phase 5 and is also able to combine the different eluents in the containers 2A and 2B in order to generate a gradient. The gradient mixer 45 can mix the already combined eluents completely thereby avoiding concentration differences in the mobile phase. After having passed the stationary phase 5, the mobile phase can flow through the detector 15 and the mobile phase switch 25. The chromatographic system also comprises a controlling system 30 that comprises a microprocessor 30A in data communication with a data processor 30B, which can process the data that are received from the controlling system. The microprocessor is in data communication with the pump 20 and with the detector 15. D/A converters 30D and A/D converters 30E are present in between the data communication lines between the microprocessor 30A and the pump 20 and between the microprocessor 30A and the detector 15. The microprocessor 30A receives data from the pump 20, for example, information about the composition of the mobile phase driven into the chromatographic system, the time of first supply of the mobile phase and the mobile phase flow rate. The microprocessor also receives data from the detector 15, for example information about the composition of the mobile phase detected at the detector at a particular time. The detector might comprise an UV or IR detector, a mass spectrometer or an apparatus for determination of the refractive index or any kind of combination thereof.

The microprocessor 30A is adapted to process the data received from the detector 15 and the pump 20 using the data processor 30B. The microprocessor 30A can send controlling signals to the detector 15 and the pump 20 and may also be adapted to control the mobile phase switch 25 via the mobile phase switch driver 30C. The reference numeral 100 represents the delay volume between the pump 20 and the detector 15. Reference numeral 110 depicts the delay volume between the detector 15 and the mobile phase switch 25.

During a chromatographic run compounds including samples to be analyzed can be injected via a sample injector 12 into the mobile phase, that is pumped by pump 20 through the mobile phase line 10.

On its way through the mobile phase line 10, the injected sample enters for example an HPLC column tube 15, completely filled with stationary phase. The injected compounds can then interact with the stationary phase resulting in different duration times.

These compounds can be eluted via the mobile phase using the pump 20 through the stationary phase and into the detector 15. The detector 15 as well as the pump 20 sends data to the microprocessor 30A for further processing and analysis. The microprocessor 30A is then adapted to control the mobile phase switch 25 via the mobile phase switch driver 30C thereby changing the direction of flow into different locations. If the information received by the pump 20 and detector 15 indicates that pure initial mobile phase having passed through the stationary phase has reached the mobile phase switch 25, the controlling system redirects the mobile phase via the mobile phase switch 25 back into its respective container 2A or 2B where it came from.

In the case, that the data received by the detector 15 and the pump 20 indicate that a mobile phase contaminated by impurities has passed the stationary phase 5, the controlling system can direct this mobile phase into the waste container 26. Compounds of interest that are eluted from the stationary phase can be directed for example into a fraction collector 27 for further action.

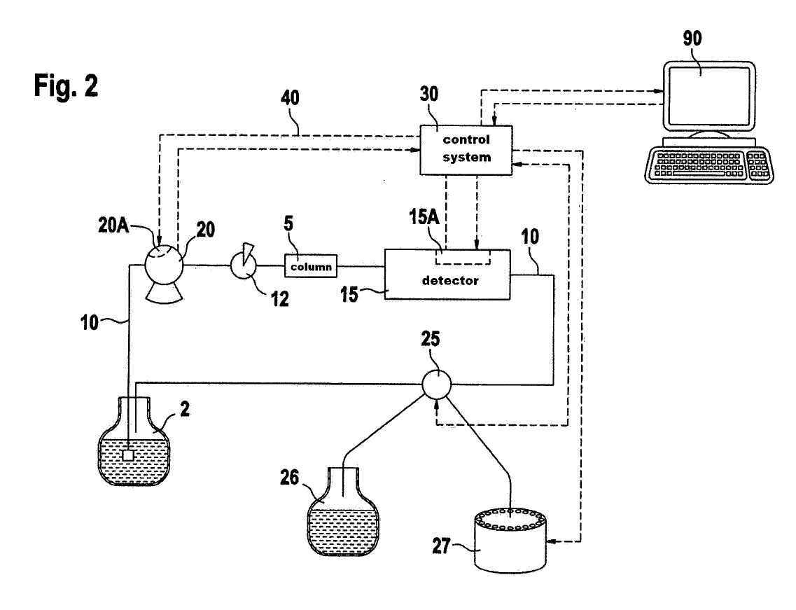

FIG. 2 is a diagram of another embodiment of a chromatographic system for isocratic runs, using just one premixed mobile phase in a container 2. In comparison to the chromatographic system shown in FIG. 1 a computer system 90 in data communication with the controlling system 30 is part of the chromatographic system. The computer system 90 enables a manual user input for control of the chromatographic system and allows monitoring the chromatographic run. Additionally microprocessors 20A and 15A are respectively part of the pump 20 and the detector 15. These microprocessors can simplify the data connection and processing between both components and the controlling system 30.

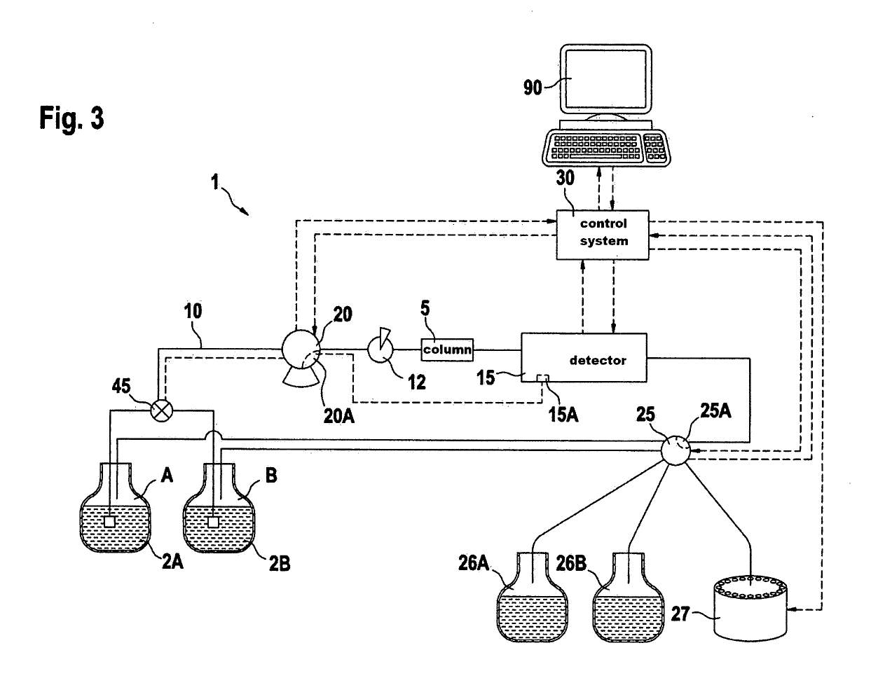

FIG. 3 is a diagram of another variant of a chromatographic system suitable to run gradient elution procedures. In this chromatographic system, the gradient mixer 45 combines and mixes the two eluents originating from the containers 2A and 2B. The gradient mixer 45 might be a part of the pump 20 or might be a separate component of the chromatographic system.

The gradient mixer 45 is in data flow communication with the two storage containers 2A and 2B containing different eluents A and B for mixing a mobile phase. Again a computer system 90 is part of the chromatographic system. The mobile phase switch 25 additionally comprises a test compound detection system 15, which includes a photodiode 25A. As mentioned above detection system 15 is also in data communication with the control system 30; detection system exactly determines the delay volume between the detector 15 and the mobile phase switch 25. To determine this delay volume, the stationary phase 5 has to be replaced with a mobile phase flow line 10, because the test compound tends to interact with the stationary phase. The mobile phase switch 25 that, for example, comprises a valve can be controlled by the controlling system 30. Depending on the information received by the control system 30, the mobile phase switch 25 selectively directs the flow of the mobile phase into a waste container 26A or into a fraction collector 27. Since the data controlling system 30 is able to determine the composition and purity of mobile phases that pass the stationary phase 5 at any time, the control system can also direct the flow of mobile phases of different compositions into a container 26B. This results in the above-mentioned new mobile phase, the composition of which can be determined by the controlling system 30 using data received from the detector 15 and the pump 20. Additionally the microprocessors 20A and 15A, which are part of the pump 20, and the detector 15 can also establish a direct data communication and processing between these components as indicated by the dashed line.

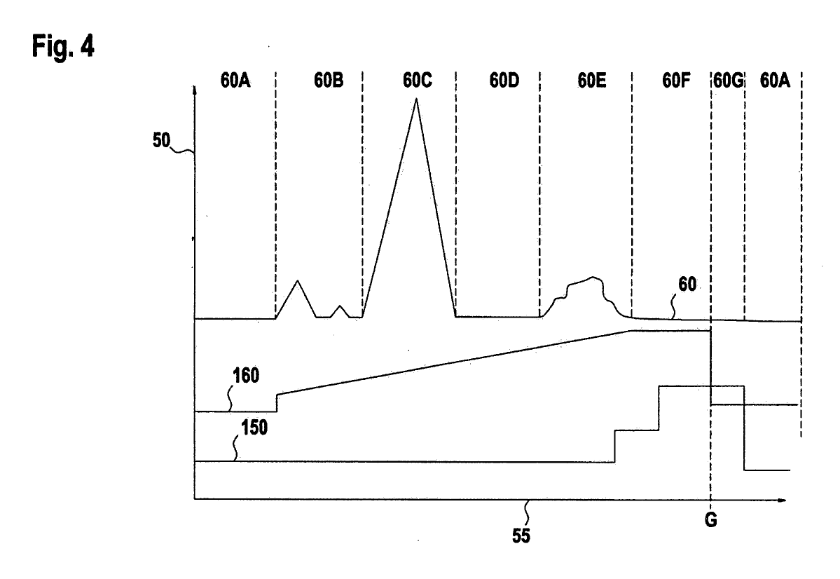

FIG. 4 is a chromatogram recorded by the detector 15. When the detector 15 is a diode array-based detector, comprising a plurality of different diodes, signals at different wavelengths can be detected at the same time. The ordinate 50 denotes the absorption, for example the UV absorption of the mobile phase at a certain, predefined wavelength, and—if present—compounds in the mobile phase, indicated by line 60, the so-called baseline.

The abscissa 55 indicates the time course of the chromatographic run. The line 150 shows the flow rate and the line 160 the mobile phase composition profile at a certain time and UV absorption at a set wavelength during the chromatographic run. The chromatogram shows the changing mobile phase composition at a predefined wavelength, caused by the presence of an injected sample mix into the sample injector 12, the result of the separation power of the separation device 5 and the gradient composition of eluent A and eluent B, preformed by the mixer 45.

For example, at the beginning of the chromatogram pure eluent A or a defined composition of eluent A and B is detected by the detector 15, whereas at the end of the chromatographic run indicated by G, pure eluent B or a defined composition identical or different from the beginning composition might be detected.

In the chromatogram shown in FIG. 4 the area denoted as 60A consists of pure eluent A which can easily be directed back into the container for eluent A when a chromatographic system, for example as shown in FIG. 3, is used (container 2A for eluent A). The area of the chromatogram denoted as 60B contains analytes eluted from the stationary phase, which are directed into the waste container in a case of being of no interest in the case of the analyte being directed into the fraction collector 27.

The area 60C denotes a peak in the chromatogram. This peak indicates that at least one compound of interest becomes eluted from the stationary phase while the concentration of eluent B relative to eluent A is increased in the gradient as shown in line 160.

This area 60C can automatically be directed to a fraction collector 27, e.g., using the chromatographic system of FIG. 3. The area 60D contains a pure mixture of a well known composition between eluent A and eluent B and can therefore automatically be directed to a third storage container for reuse (for example container 26B in FIG. 3). The peak in the area 60E indicates impurities eluted from the stationary phase while the concentration of eluent B is further increased. These impurities can also be directed automatically into a waste container (for example container 26A in FIG. 3). The area 60F contains pure eluent B that can be directed back into the original container (e.g. container 2B for solvent B in FIG. 3). Area 60G contains a mixture of eluent B and the original starting condition identical to area 60A (eluent A), while equilibrating the column with the original starting condition. This area 60G might be directed into the waste container.

Area 60A again contains pure eluent A which is applied to the stationary phase for preparation of the next chromatographic run. The solvent in this area 60A can be directed back into the container 2A, shown in FIG. 3 for eluent A. The flow rate 150 might be held constant, while eluting the components of interest from the stationary phase. Afterwards the flow rate can be increased as shown in FIG. 4 in order to accelerate the equilibration of the stationary with the original starting conditions.

The scope of the invention is not limited to the embodiments shown in the figures. Indeed variations of the chromatographic system including any kind of combination of the different features shown in the figures are also possible. Further variations are possible concerning the numbers of storage containers and fraction collectors, which are connected to the mobile phase switch. Moreover, the controlling system can be part of the detector, the pump, the mobile phase switch, or a separate component of the chromatographic system of the invention.

1. A chromatographic system comprising:
a stationary phase,
a mobile phase flow line for providing a flow path for a mobile phase,
a detector capable of detecting the composition of the mobile phase passed through the stationary phase and capable of detecting the presence of components eluted from the stationary phase,
a mobile phase supply system for delivering the mobile phase to the mobile phase flow line,
a mobile phase switch adapted to direct the flow of the mobile phase to different locations,
the mobile phase supply system, the stationary phase, the detector and the mobile phase switch being connected via the mobile phase line, wherein the detector and the mobile phase switch are located downstream in the direction of flow relative to the stationary phase, and
a controlling system arranged for (a) communicating data communication with the detector and the mobile phase supply system and (b) controling of the mobile phase supply system,
the controlling system being adapted to (a) control the mobile phase switch according to data received from the detector and the mobile phase supply system, (b) direct various mobile phases of different composition, after leaving the stationary phase, via the mobile phase switch into at least one container, resulting in a new mobile phase of new composition, and (c) determine the purity and composition of the new mobile phase by using data received from the mobile phase supply system and the detector.

2. Chromatographic system according to claim 1,
wherein the mobile phase supply system includes a pump, which is arranged to be controlled by the controlling system.

3. Chromatographic system according to claim 1,
wherein the mobile phase switch comprises a valve.

4. Chromatographic system according to claim 1,
wherein the detector and the mobile phase supply system include microprocessors for communicatiing with the controlling system.

5. Chromatographic system according to claim 1,
wherein the mobile phase flow line comprises at least one of the following components:
tubes, capillaries, sample injector.

6. Chromatographic system according to claim 1,
wherein the detector comprises a diode array based UV detector capable of storing spectra of (a) the mobile phase and (b) components eluted from the stationary phase,
wherein at least one storage container for the mobile phase is connected to the mobile phase flow line,
wherein the controlling system is adapted to redirect the flow of a mobile phase passed through the stationary phase to the storage container.

7. Chromatographic system according to claim 1,
wherein the controlling system is adapted to combine data of the composition of the mobile phase before the composition enters the stationary phase with data of the mobile phase leaving the stationary phase.

8. Chromatographic system according to claim 1,
wherein the mobile phase supply system is arranged to provide data about the mobile phase flow rate and composition and the detector is arranged to provide at least one or a combination of the following data:
change in refractive index, UV absorption, fluorescence intensity, mass/charge ratio (m/z), light scattering intensity at a specific time during a run.

9. Chromatographic system according to claim 1,
wherein the controlling system is arranged to variably adjust the mobile phase flow rate generated by the mobile phase supply system i according to data received from the detector.

10. Chromatographic system according to claim 1,
wherein the controlling system comprises a computer-system connected to the controlling system.

11. Chromatographic system according to claim 1,
wherein the mobile phase switch comprises a second detector for a test compound,
wherein the mobile phase switch is arranged to provide data about the test compound to the controlling system.

12. Chromatographic system according to claim 1,
wherein a mobile phase mixer is part of the system,
wherein the controlling system is adapted to control the mobile phase mixer, for enabling the mixing of at least two eluents to a mobile phase enabling a gradient and/or step gradient elution.

13. Chromatographic system according to claim 1,
wherein the mobile phase supply system and the detector are arranged to provide the following data:
mobile phase flow rate, the composition of the mobile phase at the beginning of the gradient, the composition of the mobile phase at the end of the gradient, the purity of the mobile phase, the steepness(es) of the gradient(s) and its duration and occurrence of the mobile phase at the detector.

14. Chromatographic system according to claim 1,
further including an electronic microprocessor for direct data communication between the mobile phase supply system and the detector,
the electronic microprocessor being part of at least the mobile phase supply system or the detector.

15. A method of operating a chromatographic system, the system including a mobile phase supply system that delivers a mobile phase, a stationary phase, a sample injector, a detector and a mobile phase switch that directs the flow of a mobile phase to different locations, all being connected via a mobile phase flow line, the method comprising:
A) applying an initial mobile phase to the stationary phase by mixing together, in the mobile phase supply system at least two different eluents in a variable manner resulting in the initial mobile phase being applied to the stationary phase, running a gradient elution and/or a step gradient elution,
B) determining the composition and purity of the mobile phase after passing the stationary phase by using data received from the detector and data received from the mobile phase supply system,
C) directing the mobile phase passed through the stationary phase into a container depending on the data received in step (B) by using the mobile phase switch, whereby mobile phases of different composition are directed into at least one container resulting in a new mobile phase
D) determining the composition of the new mobile phase by using data received in step (B).

16. Method according to claim 15,
wherein in step (B) at least one of the following data of the mobile phase is received from the detector:
refractive index, UV spectrum, fluorescence spectrum, TIC spectrum, light scattering information,
wherein in step (B) at least one of the following data is received from the mobile phase supply system:
mobile phase flow rate, mobile phase composition and duration of delivery of the mobile phase.

17. Method of claim 15,
wherein mobile phase supply system submits at least one of the following additional data:
composition of the mobile phase at the beginning of the gradient, composition of the mobile phase at the end of the gradient and the duration of the gradient.

18. Method of claim 15,
further including using at least one container for storage of the initial mobile phase,
wherein in step (C) the mobile phase with the same composition as the initial mobile phase is automatically directed back into the at least one container.

19. Method according to claim 15,
wherein in step (E) includes automatically determining the delay time of the mobile phase between the mobile phase supply system and the mobile phase switch by using at least one the following data:
refractive index, UV spectrum, fluorescence spectrum, mass spectrum, light scattering information,
mobile phase flow rate received from the mobile phase supply system, composition of the mobile phase delivered by the mobile phase supply system and
volume of the mobile phase flow line connecting the detector and the mobile phase switch.

20. Method according to claim 15,
wherein step C) includes automatically directing (a) mobile phases having no impurities into storage containers for recycling and (b) mobile phases having analytes of interest to a fraction collector.

21. A chromatographic system arranged to include a stationary phase, a mobile phase flow line, a detector, a mobile phase supply system, an injection device and a mobile phase switch, a controlling system in data communication with the detector and the mobile phase supply system, wherein the controlling system being arranged for automatically directing the flow of the mobile phase via the mobile phase switch into different containers depending on data received by the detector and the mobile phase supply system.
